(19) United States
(12) Patent Application Publication
(10) Pub. No.: US 2007/0125973 A1
(43) Pub. Date: Jun. 7, 2007

(54) Erasing device and erasing method

(75) Inventor: Keisuke Koishikawa, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/583,905

(22) Filed: Oct. 20, 2006

(30) Foreign Application Priority Data
Oct. 25, 2005 (JP) 2005-310003

(51) Int. Cl. G01N 23/04

(52) U.S. Cl. 250/588

(57) ABSTRACT

An erasing time required to erase radiation image information remaining in an image storage recording medium is calculated based on IP information supplied from an IP information reader and radiation image information read from the image storage recording medium by an image information reader. A display unit displays the erasing time and confirmative information as to whether an erasing process is to be performed or not. If the erasing process is to be performed as selected by an erasing process selector, then the erasing process is performed.

### BACKGROUND OF THE INVENTION

1. Field of the Invention

The present invention relates to a device for and a method of erasing remaining image information from an image storage recording medium by applying erasing light to the image storage recording medium.

2. Description of the Related Art

When a certain phosphor is exposed to an applied radiation (X-rays, α-rays, β-rays, γ-rays, electron beams, ultraviolet radiation, or the like), it stores a part of the energy of the radiation, and, when the phosphor is subsequently exposed to applied stimulating rays such as visible light, it emits photostimulated luminescence in proportion to the stored energy of the radiation.

There has been developed a radiation image information reading apparatus which employs a stimulable phosphor panel comprising such a phosphor. The stimulable phosphor panel temporarily stores radiation image information of a subject such as a human body or the like. The radiation image information reading apparatus applies stimulating light to the stimulable phosphor panel to obtain photostimulated luminescence, photoelectrically reads the photostimulated luminescence to obtain an image signal, and processes the image signal to produce an image suitable for use in diagnostic applications.

After the radiation image information has been read from the stimulable phosphor panel, erasing light containing light in the wavelength range of the stimulating light is applied to the stimulable phosphor panel to erase remaining radiation image information therefrom for repetitive use of the stimulable phosphor panel. Some radiation image information reading apparatus incorporate an erasing device for applying erasing light to a stimulable phosphor panel to erase remaining radiation image information therefrom.

Radiation image information may be acquired by a phototransducer-type radiation detector for solid rather than a stimulable phosphor panel (see Japanese Laid-Open Patent Publication No. 2004-154409). The phototransducer-type solid-state radiation detector comprises a matrix of solid-state detecting elements which, when irradiated with a radiation, store an electrostatic latent image depending on the dose of the radiation. For reading the electrostatic latent image, reading light is applied to the solid-state radiation detector to cause the latter to generate an electric current, and the value of the electric current output from the solid-state radiation detector is acquired as representing radiation image information. Then, erasing light is applied to the solid-state radiation detector to erase remaining radiation image information as electrostatic latent image therefrom so that the solid-state radiation detector can be used again.

In order to fully erase remaining radiation image information from an image storage recording medium such as a stimulable phosphor panel or a solid-state radiation detector, it is desirable to apply a sufficient amount of erasing light to the image storage recording medium. A sufficient amount of erasing light may be produced by a high-output erasing light source or a prolonged erasing process. However, the high-output erasing light source is relatively expensive, and the prolonged erasing process is time-consuming.

For reducing the cost and time required for erasing remaining radiation image information, there has been proposed a technique for adjusting the amount of erasing light applied to a stimulable phosphor panel based on the level of radiation energy that remains in the stimulable phosphor panel, as disclosed in Japanese Laid-Open Patent Publication No. 2001-33902, for example.

The dose of a radiation that is applied to store and record radiation image information in an image storage recording medium differs from subject to subject and from imaged region to imaged region. The amount of radiation image information that remains in the image storage recording medium after desired radiation image information has been read therefrom depends greatly on the dose of the applied radiation. As the dose of the applied radiation increases, the amount of erasing light required to erase the remaining radiation image information also increases and the time required to erase the remaining radiation image information is extended.

While an image storage recording medium that needs a long time to erase remaining radiation image information therefrom is being processed in an erasing process, an emergency need may arise to record radiation image information in an image storage recording medium. In such a case, unless another image storage recording medium from which remaining radiation image information has been erased is available for immediate use, the process of recording radiation image information should be suspended until the erasing process on the image storage recording medium is completed.

### SUMMARY OF THE INVENTION

It is a general object of the present invention to provide an erasing device and an erasing method which allow the user to confirm and select, in advance, whether an erasing process is to be performed or not, based on erasing information required to erase image information that remains in an image storage recording medium.

A major object of the present invention is to provide an erasing device and an erasing method which can quickly supply a recordable image storage recording medium depending on a process of storing and recording image information.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a radiation image information reading apparatus according to an embodiment of the present invention;

FIG. 2 is a vertical cross-sectional view showing an internal structure of the radiation image information reading apparatus according to the embodiment;

FIG. 3 is a block diagram of a control circuit of the radiation image information reading apparatus according to the embodiment;

FIG. 4 is a diagram showing an erasure table set in an erasure table memory of the control circuit shown in FIG. 3; and

FIG. 5 is a flowchart of an operation sequence of the radiation image information reading apparatus according to the embodiment.

### DESCRIPTION OF THE PREFERRED EMBODIMENT

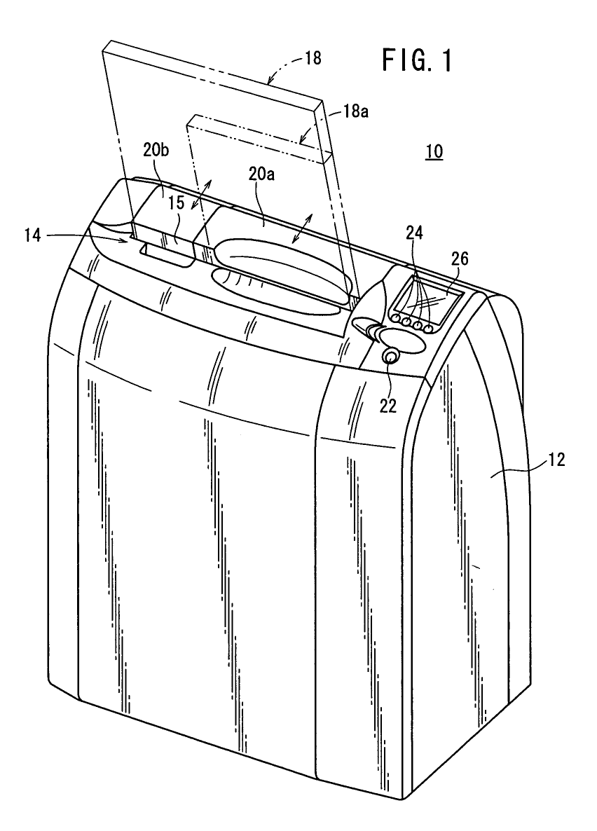

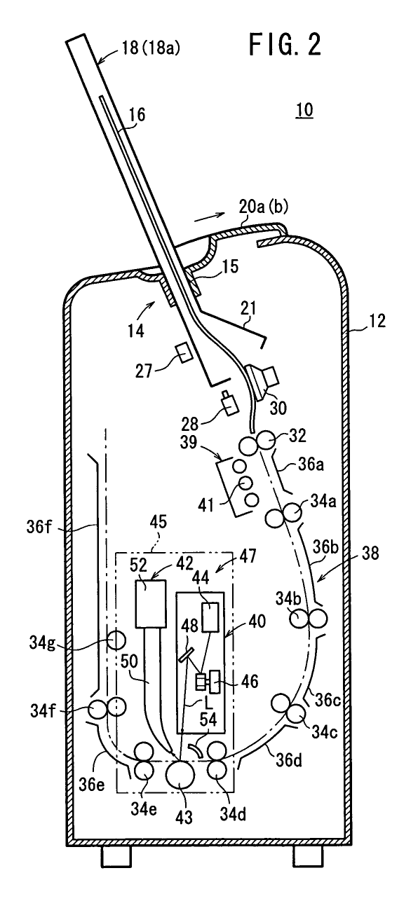

FIG. 1 shows in perspective a radiation image information reading apparatus according to an embodiment of the present invention, and FIG. 2 shows in vertical cross section an internal structure of the radiation image information reading apparatus according to the embodiment.

As shown in FIG. 1, a radiation image information reading apparatus, generally designated by the reference numeral 10, according to an embodiment of the present invention has a cassette loader 14 disposed in an upper portion of a casing 12. The cassette loader 14 has a loading slot 15 for being loaded with a cassette 18 (18a) housing therein a stimulable phosphor panel (hereinafter also referred to as “IP”) 16 which stores and records radiation image information. The cassette 18a is smaller in size than the cassette 18.

The cassette loader 14 has covers 20a, 20b which are displaceable in the directions indicated by the arrows. When the larger cassette 18 is to be loaded, both the covers 20a, 20b are displaced to open the loading slot 15 in its entirety. When the smaller cassette 18a is to be loaded, only the cover 20a is displaced to open the loading slot 15 only partly. With the loading slot 15 being open only partly, excessive dust and dirt particles are prevented from entering the radiation image information reading apparatus 10 through the loading slot 15. A power supply button 22, operation buttons 24, a display unit 26, and other components are disposed on the casing 12 laterally of the cassette loader 14.

As shown in FIG. 2, the radiation image information reading apparatus 10 accommodates, in a region close to the loading slot 15, an IP information reader 27 (type information reading means) for reading type information (hereinafter referred to as “IP information”) about the size, sensitivity, etc., a unique number, etc. of the stimulable phosphor panel 16 stored in the loaded cassette 18 (18a), an unlock mechanism 28 for unlocking a lid 21 of the cassette 18 (18a), a suction cup 30 for attracting and removing the stimulable phosphor panel 16 from the cassette 18 (18a) with the lid 21 being open, and nip rollers 32 for gripping and feeding the stimulable phosphor panel 16 removed by the suction cup 30.

The IP information reader 27 may comprise a reading means such as a bar-code reader, an RFID (Radio Frequency Identification) reader, or the like for reading the IP information recorded in a bar code, an IC chip, or the like that is mounted on the cassette 18 (18a) or the stimulable phosphor panel 16.

The nip rollers 32 are followed by a plurality of feed rollers 34a through 34g and a plurality of guide plates 36a through 36f which jointly make up a curved feed path 38. The curved feed path 38 extends downwardly from the cassette loader 14, then substantially horizontally in a lowermost portion near the bottom of the casing 12, and then substantially vertically upwardly. The curved feed path 38 is effective in reducing the overall size of the radiation image information reading apparatus 10.

Between the nip rollers 32 and the feed rollers 34a, there is disposed an erasing unit (erasing means) 39 for erasing radiation image information which remains in the stimulable phosphor panel 16 after desired radiation information has been read therefrom. The erasing unit 39 has a plurality of erasing light sources 41 such as cold-cathode tubes for emitting erasing light.

A platen roller 43 is disposed between the feed rollers 34d, 34e that are positioned in the lowermost portion of the curved feed path 38. The platen roller 43 is positioned below a scanning unit 47 for reading radiation image information from the stimulable phosphor panel 16. The scanning unit 47 is placed in the housing 45.

The scanning unit 47 has a stimulator 40 for emitting a laser beam L as stimulating light and scanning the stimulable phosphor panel 16 with the laser beam L, and an image information reader (image information reading means) 42 for reading photostimulated luminescence which is emitted from the stimulable phosphor panel 16 upon exposure to the laser beam L. The emitted photostimulated luminescence represents the radiation image information recorded in the stimulable phosphor panel 16.

The stimulator 40 comprises a laser oscillator 44 for outputting the laser beam L, a polygon mirror 46 which is a rotating polygonal mirror for deflecting the laser beam L in a main scanning direction of the stimulable phosphor panel 16, and a mirror 48 for reflecting the laser beam L to the stimulable phosphor panel 16 that passes across and over the platen roller 43.

The image information reader 42 comprises a light guide 50 having a lower end disposed near the stimulable phosphor panel 16 over the platen roller 43, and a photomultiplier 52 connected to the upper end of the light guide 50 for converting the photostimulated luminescence emitted from the stimulable phosphor panel 16 into an electric signal. A light collecting mirror 54 for collecting the photostimulated luminescence highly efficiently is disposed near the lower end of the light guide 50.

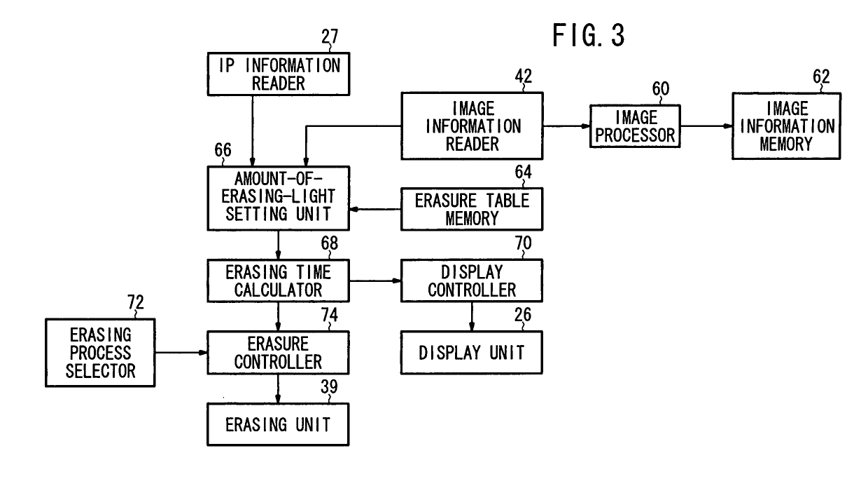

As shown in FIG. 3, the radiation image information reading apparatus 10 has a control circuit including an image processor 60 for processing the image signal photoelectrically generated by the photomultiplier 52 of the image information reader 42 to produce radiation image information suitable for use in diagnostic applications, and an image information memory 62 for storing the radiation image information produced by the image processor 60.

The control circuit also has an amount-of-erasing-light setting unit 66 for setting an amount of erasing light required to erase radiation image information which remains in the stimulable phosphor panel 16 from which desired radiation image information has been read, based on IP information serving as erasing information acquired by the IP information reader 27, radiation image information serving as erasing information read by the image information reader 42, and an erasure table stored in an erasure table memory (erasure table storing means) 64.

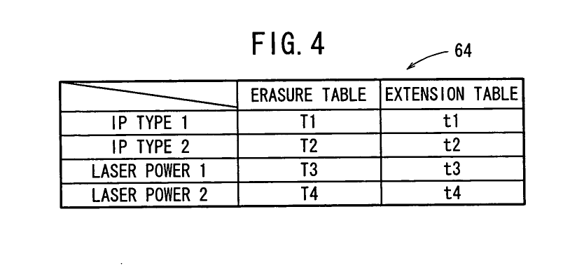

As shown in FIG. 4, the erasure table has a plurality of erasure tables T1 through T4 that can be selected depending on IP type 1 and IP type 2 based on the sensitivity of the stimulable phosphor panel 16 obtained from the IP information, and laser power 1 and laser power 2 for the stimulating light output from the laser oscillator 44. Each of the erasure tables T1 through T4 determines the relationship between the radiation image information obtained from the stimulable phosphor panel 16 and the amount of erasing light required to erase the radiation image information remaining in the stimulable phosphor panel 16. The erasure tables T1 through T4 are combined with respective extension tables (correction tables) t1 through t4 for adding respective amounts of erasing light in case some of the erasing light sources 41 are de-energized due to a failure or the like. Erasure tables may be established based on combinations of different stimulable phosphor panel sensitivity levels and different laser powers for the stimulating light.

The control circuit also has an erasing time calculator (erasing time calculating means) 68 for calculating an erasing time required for the erasing unit 39 to perform its erasing process from the amount of erasing light which has been set by the amount-of-erasing-light setting unit 66, and a display controller 70 for controlling the display unit 26 to display confirmative information for the user to confirm whether the erasing process is to be performed or not, based on the calculated erasing time, and also to display the erasing time.

The control circuit further includes an erasing process selector (erasing process selecting means) 72 for selecting whether the erasing process is to be performed or not, based on the confirmative information displayed on the display unit 26, and an erasure controller 74 for controlling the erasing unit 39 based on the erasing time calculated by the erasing time calculator 68 if the erasing process is to be performed as selected by the erasing process selector 72, and applying erasing light to the stimulable phosphor panel 16 to perform the erasing process.

The erasing process selector 72 may be in the form of one of the operation buttons 24 (see FIG. 1) disposed laterally of the cassette loader 14, or a display means such as a touch panel or the like for the user to directly select an icon representing the confirmative information displayed on the display unit 26.

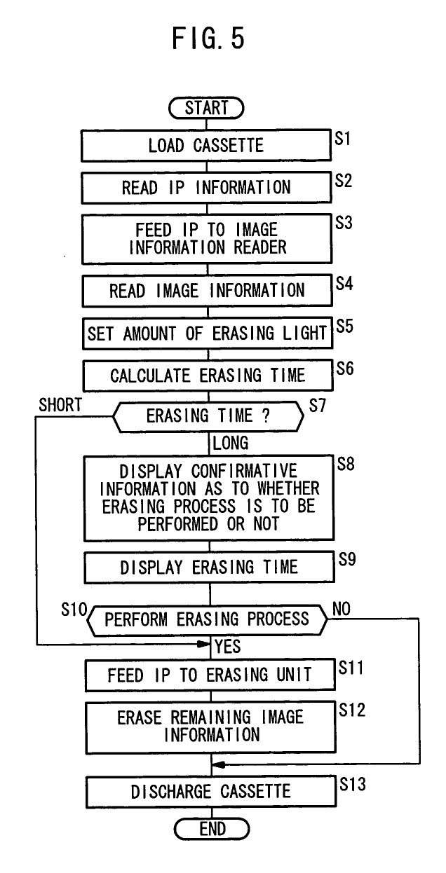

The radiation image information reading apparatus 10 according to the present embodiment is basically constructed as described above. Operation of the radiation image information reading apparatus 10 will be described below with reference to a flowchart shown in FIG. 5.

The cassette 18 (18a) which stores therein the stimulable phosphor panel 16 with radiation image information stored and recorded therein is loaded, with the lid 21 down, into the loading slot 15 of the cassette loader 14 in step S1.

When the cassette 18 (18a) is loaded properly into the radiation image information reading apparatus 10, the IP information reader 27, which is disposed closely to the cassette loader 14, reads IP information including the type of the stimulable phosphor panel 16, etc. from the cassette 18 (18a) or the stimulable phosphor panel 16 housed therein, in step S2.

After the IP information is read, the unlock mechanism 28 is actuated to unlock and open the lid 21. Then, the suction cup 30 attracts the stimulable phosphor panel 16, removes the stimulable phosphor panel 16 from the cassette 18 (18a), and supplies the stimulable phosphor panel 16 to the nip rollers 32. The stimulable phosphor panel 16 is gripped by the nip rollers 32 and fed through the curved feed path 38 formed with the feed roller 34a through 34g and the guide plates 36a through 36f to a position below the image information reader 42 in step S3.

Below the image information reader 42, the stimulable phosphor panel 16 is fed substantially horizontally in an auxiliary scanning direction by the feed rollers 34d, 34e. The laser oscillator 44 of the stimulator 40 emits the laser beam L is reflected and deflected by the polygon mirror 46 which is rotating at a high speed, and then reflected by the reflecting mirror 48 to the stimulable phosphor panel 16 whose lower surface is supported on the platen roller 43, thereby scanning the stimulable phosphor panel 16 in the main scanning direction which is perpendicular to the auxiliary scanning direction.

Upon exposure to the laser beam L, the stimulable phosphor panel 16 is stimulated to emit photostimulated luminescence depending on the radiation image information that is recorded in the stimulable phosphor panel 16. The photostimulated luminescence is either directly applied or reflected by the light collecting mirror 54 to the lower end of the light guide 50 which is disposed near the stimulable phosphor panel 16 and which extends in the main scanning direction. Within the light guide 50, the photostimulated luminescence is repeatedly reflected by inner surfaces thereof and led to the photomultiplier 52 on the upper end of the light guide 50. The photomultiplier 52 converts the applied photostimulated luminescence into an electric signal representing the recorded radiation image information. In this manner, the radiation image information recorded in the stimulable phosphor panel 16 is read in step S4.

The read radiation image information is processed by the image processor 60 and stored in the image information memory 62. If necessary, the radiation image information may be transmitted to an external image processor by a communicating means, not shown.

The radiation image information read by the image information reader 42 is also supplied to the amount-of-erasing-light setting unit 66. The amount-of-erasing-light setting unit 66 is also supplied with the IP information from the IP information reader 27. Then, the amount-of-erasing-light setting unit 66 sets an amount of erasing light required to erase radiation image information which remains in the stimulable phosphor panel 16 after the desired radiation image information has been read therefrom, using the radiation image information and the IP information, both of which serve as erasure information, and the erasure table stored in the erasure table memory 64, in step S5.

For example, the amount of erasing light required to fully erase the remaining radiation image information may differ depending on the sensitivity of the stimulable phosphor panel 16. In this case, the erasure table T1 for IP type 1 or the erasure table T2 for IP type 2 is selected from the erasure table memory 64 based on the information of sensitivity obtained from the IP information. Furthermore, the remaining radiation image information may vary depending on the power of the laser beam L applied to read radiation image information from the stimulable phosphor panel 16. In this case, the erasure table T3 for laser power 1 set in the laser oscillator 44 or the erasure table T4 for laser power 2 set in the laser oscillator 44 is selected from the erasure table memory 64. If the amount of erasing light is lowered due to a failure of one or more of the erasing light sources 41, then one or more of the extension tables t1 through t4 for Increasing the amount of erasing light are selected together with one or more of the erasure tables T1 through T4 from the erasure table memory 64.

The amount-of-erasing-light setting unit 66 selects a table combination based on the IP information, etc. from the erasure tables T1 through T4 and the extension tables t1 through t4, and sets an amount of erasing light required to fully erase the remaining radiation image information based on the maximum value of the radiation image information supplied from the image information reader 42.

In setting an amount of erasing light, the amount-of-erasing-light setting unit 66 may use the dose of a radiation applied to record the radiation image information in the stimulable phosphor panel 16, rather than the radiation image information read by the image information reader 42. If the radiation image information reading apparatus 10 has no IP information reader 27 and hence no IP information is available, then the amount-of-erasing-light setting unit 66 may select erasure tables T1 through T4 with higher values being set for the amount of erasing light.

Then, the erasing time calculator 68 calculates an erasing time required to fully erase the remaining radiation image information, based on the amount of erasing light set in step S5, in step S6. If the calculated erasing time is longer than a predetermined reference erasing time in step S7, then the erasing time calculator 68 instructs the display controller 70 to display confirmative information as to whether the erasing process is to be performed or not and also the calculated erasing time on the display unit 26 in steps S8, S9.

For example, the display unit 26 displays messages “ERASE NOW” and “ERASE LATER” and also “ERASING TIME” as a time required to fully erase the remaining radiation image information, as the confirmative information. Whether the confirmative information is to be displayed or not may be determined according to the maximum value of the radiation image information read by the image information reader 42, rather than the calculated erasing time.

The user confirms the displayed messages and erasing time. If there is a sufficient time available before a next stimulable phosphor panel 16 is supplied to record radiation image information, then the user operates an operation button 24 to select “ERASE NOW”, instructing the radiation image information reading apparatus 10 to perform the erasing process. Conversely, if the erasing process for the present stimulable phosphor panel 16 is time-consuming and a stimulable phosphor panel 16 that can record radiation image information needs to be supplied as quickly as possible, then the user operates an operation button 24 to select “ERASE LATER” to give priority to the erasing process for a stimulable phosphor panel 16 having a shorter erasing time, i.e., to give priority to the erasing process for a stimulable phosphor panel 16 exposed to a relatively low dose of radiation in a previous image recording cycle, in step S10. If “ERASE LATER” is selected in step 10, then the stimulable phosphor panel 16 that is presently loaded in the radiation image information reading apparatus 10 is placed back into the cassette 18 (18a) and discharged out of the radiation image information reading apparatus 10 in step S13.

If “ERASE NOW” is selected in step 10, then the stimulable phosphor panel 16 is fed to the erasing unit 39 in step S11. The erasure controller 74 energizes the erasing light sources 41 for the erasing time calculated by the erasing time calculator 68 to apply erasing light to the stimulable phosphor panel 16, thereby erasing the remaining radiation image information from the stimulable phosphor panel 16 in step S12.

The stimulable phosphor panel 16, from which the remaining radiation image information has been fully erased, is placed back into the cassette 18 (18a) loaded in the cassette loader 14. Then, the lid 21 is closed, and the cassette 18 (18a) is discharged in step S13. The discharged cassette 18 (18a) with the stimulable phosphor panel 16 stored therein will be used to record radiation image information in a next cycle.

If the erasing time calculated by the erasing time calculator 68 is shorter than the predetermined reference erasing time in step S7, then no message is displayed on the display unit 26, and the stimulable phosphor panel 16 is fed to the erasing unit 39 to erase the remaining radiation image information therefrom in steps S11, S12. Then, the stimulable phosphor panel 16 is placed back into the cassette 18 (18a) and discharged in step 13. Even if the calculated erasing time is shorter than the predetermined reference erasing time, the display unit 26 may display confirmative information for the user to confirm whether the erasing process is to be performed or not.

In the above embodiment, an amount of erasing light is set using erasure tables based on the erasing information and the radiation image information, and an erasing time for which the amount of erasing light can be applied to the stimulable phosphor panel 16 is calculated. However, an erasing time may be set directly from the erasing information and the radiation image information, and the erasing process may be performed for the erasing time thus set. Alternatively, the amount of erasing light emitted from the erasing light sources 41, rather than the erasing time, may be controlled in the erasing process.

The principles of the present invention are also applicable where a phototransducer-type solid-state radiation detector is used, rather than the stimulable phosphor panel 16, as an image storage recording medium. Furthermore, the image information stored and recorded in the image storage recording medium is not limited to image information which is recorded by applying a radiation to the image storage recording medium, but may be image information which is recorded by applying a light beam to the image storage recording medium.

Although a certain preferred embodiment of the present invention has been shown and described in detail, it should be understood that various changes and modifications may be made therein without departing from the scope of the appended claims.

What is claimed is:

1. A device for erasing remaining image information from an image storage recording medium by applying erasing light to the image storage recording medium, comprising:
erasure information acquiring means for acquiring erasure information required to erase the image information remaining in the image storage recording medium;
display means for displaying confirmative information to confirm whether an erasing process for erasing the remaining image information is to be performed or not, based on the acquired erasure information;
erasing process selecting means for selecting whether the erasing process is to be performed or not, based on the displayed confirmative information; and
erasing means for applying the erasing light based on said erasure information to said image storage recording medium to erase the remaining image information, if the erasing process is to be performed as selected by said erasing process selecting means.

2. A device according to claim 1, wherein said erasure information acquiring means comprises:
image information reading means for reading image information stored and recorded in said image storage recording medium;
wherein said erasure information acquiring means acquires said image information read by said image information reading means as said erasure information.

3. A device according to claim 1, wherein said erasure information acquiring means comprises:
type information reading means for reading type information of said image storage recording medium;
wherein said erasure information acquiring means acquires said type information read by said type information reading means as said erasure information.

4. A device according to claim 1, further comprising:
erasing time calculating means for calculating an erasing time required to erase the remaining image information, based on the acquired erasure information;
wherein said display means displays said erasing time together with said confirmative information.

5. A device according to claim 4, wherein said display means displays said erasing time together with said confirmative information if said erasing time is longer than a predetermined reference erasing time.

6. A device according to claim 1, further comprising:
erasure table storing means for storing an erasure table representing the relationship between said erasure information and amounts of erasing light required to erase the remaining image information;
wherein said erasing means applies an amount of erasing light which is set using said erasure table based on the acquired erasure information, to said image storage recording medium.

7. A device according to claim 6, wherein said erasure table storing means stores a correction table for correcting the amount of erasing light depending on a state of said erasing means.

8. A device according to claim 1, wherein said erasing means controls an erasing time for which said erasing light is applied, based on said erasure information.

9. A device according to claim 1, wherein said erasing means controls an amount of the erasing light based on said erasure information.

10. A device according to claim 1, wherein said image storage recording medium comprises a stimulable phosphor panel.

11. A device according to claim 1, wherein said image storage recording medium comprises a solid-state radiation detector.

12. A method of erasing remaining image information from an image storage recording medium by applying erasing light to the image storage recording medium, comprising the steps of:
acquiring erasure information required to erase the image information remaining in the image storage recording medium;
displaying confirmative information to confirm whether an erasing process for erasing the remaining image information is to be performed or not, based on the acquired erasure information;
selecting whether the erasing process is to be performed or not, based on the displayed confirmative information; and
applying the erasing light based on said erasure information to said image storage recording medium to erase the remaining image information, if the erasing process is to be performed as selected in said selecting step.

13. A method according to claim 12, wherein said acquiring step comprises the steps of:
reading image information stored and recorded in said image storage recording medium; and
acquiring said image information as said erasure information.

14. A method according to claim 12, wherein said acquiring step comprises the steps of:
reading type information of said image storage recording medium; and
acquiring said type information as said erasure information.

15. A method according to claim 12, further comprising the steps of:
calculating an erasing time required to erase the remaining image information, based on the acquired erasure information; and
displaying said erasing time together with said confirmative information.
